(19) United States
(12) Patent Application Publication
(10) Pub. No.: US 2018/0293598 A1
(43) Pub. Date: Oct. 11, 2018

(54) PERSONAL BEHAVIOR ANALYSIS DEVICE, PERSONAL BEHAVIOR ANALYSIS SYSTEM, AND PERSONAL BEHAVIOR ANALYSIS METHOD

(71) Applicant: PANASONIC INTELLECTUAL PROPERTY MANAGEMENT CO., LTD., Osaka (JP)

(72) Inventor: Yuji SATO, Kanagawa (JP)

(73) Assignee: PANASONIC INTELLECTUAL PROPERTY MANAGEMENT CO., LTD., Osaka (JP)

(21) Appl. No.: 15/573,989

(22) PCT Filed: Mar. 22, 2016
(86) PCT No.: PCT/JP2016/001626

§ 371 Date: Nov. 14, 2017

(30) Foreign Application Priority Data
Jun. 2, 2015 (JP) 2015-112241

(51) Int. Cl. G06Q 30/02; G06K 9/00

(52) U.S. Cl. CPC G06Q 30/0201; G06K 9/00335

(57) ABSTRACT

It is possible to acquire analysis information pertaining to a customer's commodity acquisition behavior with high accuracy by discriminating whether a subject of an action of reaching out to a display shelf area is a store employee or a customer. The personal behavior analysis device includes: an image analyzer that analyzes captured images around a display shelf area, detects a person staying in front of a display shelf area, and acquires analysis information pertaining to physical states of the person; an access action detector that detects an access action, based on the analysis information; a behavior determiner that determines whether or not the access action corresponds to a prescribed behavioral pattern based on access action occurrence circumstances; and an analysis information generator that selects the access action and generates analysis information pertaining to the access action occurrence circumstance.

### TECHNICAL FIELD

The present disclosure relates to a personal behavior analysis device, a personal behavior analysis system, and a personal behavior analysis method, which are used to perform analysis pertaining to behavior of a person who picks up a commodity displaced in a display shelf area.

### BACKGROUND ART

In a retail store, such as a convenience store or a supermarket, behavior, in which a customer picks up a commodity displayed on a display shelf, indicates a size of the interest of the customer with respect to the commodity. In addition, in a case where the customer picks up the commodity but does not purchase the commodity, it is considered that there is a problem in commodity explanation, a display method, or the like. Therefore, in a case where analysis pertaining to commodity acquisition behavior, in which the customer picks up the commodity on the display shelf, is performed, it is possible to acquire advantageous information in managing the store.

In a case where the analysis pertaining to commodity acquisition behavior of the customer is performed, it is necessary to observe a customer who stays in front of the display shelf and to detect the commodity acquisition behavior of the customer. As a technology related to the case, in the related art, a technology for detecting an action of reaching out to the display shelf based on captured images acquired by imaging a periphery of the display shelf by cameras using an image recognition technology has been known (see PTL 1 and PTL2).

### CITATION LIST

### Patent Literature

PTL 1: Japanese Patent Unexamined Publication No. 2001-128814

PTL 2: Japanese Patent Unexamined Publication No. 2012-088878

### SUMMARY OF THE INVENTION

Furthermore, in the store, a store employee performs a commodity management work including an arrangement work, such as face up work of rearranging commodities on a display shelf, a restocking work of arranging new commodities on the display shelf, a disposal work of picking up unsold commodities from the display shelf, in front of the display shelf. At this time, the store employee performs an action of reaching out to the display shelf similar to the customer. However, in the related art, although it is possible to detect the action of reaching out to the display shelf, it is difficult to discriminate whether a subject of the action is the store employee or the customer. Therefore, there is a problem in that the behavior of the store employee is included in analysis information, and thus it is difficult to acquire analysis information pertaining to the commodity acquisition behavior of the customer with high accuracy.

The present disclosure is provided to solve the above problem of the related art, and a main object of the present disclosure is to provide a personal behavior analysis device, a personal behavior analysis system, and a personal behavior analysis method, which are configured to discriminate whether a subject of an action of reaching out to a display shelf area is a store employee or a customer and to acquire analysis information pertaining to a commodity acquisition behavior of the customer with high accuracy.

A personal behavior analysis device according to the present disclosure is a personal behavior analysis device, which performs analysis pertaining to behavior of a person who picks up a commodity displaced in a display shelf area, including: an image analyzer that analyzes captured images acquired by imaging a periphery of the display shelf area, detects a person staying in front of the display shelf area, and acquires analysis information pertaining to physical states of the person; an access action detector that detects an access action, in which a target person reaches out to the display shelf area, based on the analysis information acquired by the image analyzer; a behavior determiner that determines whether or not the access action corresponds to a prescribed behavior pattern based on occurrence circumstances of the access action detected by the access action detector; and an analysis information generator that selects the access action according to whether or not the access action corresponds to the behavior pattern based on a determination result acquired by the behavior determiner and a detection result acquired by the access action detector, and generates the analysis information pertaining to the occurrence circumstances of the access action.

In addition, a personal behavior analysis system according to the present disclosure is a personal behavior analysis system, which performs analysis pertaining to behavior of a person who picks up a commodity displaced in a display shelf area, including: a camera that images a periphery of the display shelf area; and a plurality of information processing devices, in which any one of the plurality of information processing devices includes an image analyzer that analyzes captured images acquired by imaging a periphery of the display shelf area by the camera, detects a person staying in front of the display shelf area, and acquires analysis information pertaining to physical states of the person; an access action detector that detects an access action, in which a target person reaches out to the display shelf area, based on the analysis information acquired by the image analyzer; a behavior determiner that determines whether or not the access action corresponds to a prescribed behavior pattern based on occurrence circumstances of the access action detected by the access action detector; and an analysis information generator that selects the access action according to whether or not the access action corresponds to the behavior pattern based on a determination result acquired by the behavior determiner and a detection result acquired by the access action detector, and generates the analysis information pertaining to the occurrence circumstances of the access action.

In addition, a personal behavior analysis method according to the present disclosure is a personal behavior analysis method of causing an information processing device to perform an analysis process pertaining to behavior of a person who picks up a commodity displaced in the display shelf area, the personal behavior analysis method including: analyzing captured images acquired by imaging a periphery of the display shelf area, detecting a person staying in front of the display shelf area, and acquiring analysis information pertaining to physical states of the person; detecting an access action, in which a target person reaches out to the display shelf area, based on the analysis information acquired in the analyzing; determining whether or not the access action corresponds to a prescribed behavior pattern based on occurrence circumstances of the access action acquired in the detecting; and selecting the access action according to whether or not to correspond to the behavior pattern based on a determination result acquired in determining and a detection result acquired in the detecting of the access action, and generating the analysis information pertaining to occurrence circumstances of the access action.

According to the present disclosure, it is possible to generate the analysis information pertaining to occurrence circumstances of the access action according to the behavior pattern of the person. Furthermore, in a case where the determination pertaining to the behavior pattern of the store employee and the customer is performed, it is possible to discriminate whether the subject of the access action is the store employee or the customer, and it is possible to acquire the analysis information pertaining to a commodity acquisition behavior of the customer with high accuracy. In addition, in a case where the determination pertaining to the behavior pattern is performed for the work item of the commodity management work performed by the store employee, it is possible to acquire the analysis information pertaining to a specific work item with high accuracy.

### BRIEF DESCRIPTION OF DRAWINGS

FIG. 1 is a whole configuration diagram illustrating a personal behavior analysis system according to an embodiment.

FIG. 2 is a plan view illustrating a layout of a store and installation status of cameras 1.

FIG. 3 is a functional block diagram illustrating a schematic configuration of a PC 3.

FIG. 4 is an explanatory diagram illustrating an example of a body pose in a case where a person reaches out to a display shelf area (display shelf).

FIG. 5A is an explanatory diagram illustrating an example of stay frame data accumulated in an analysis information storage 22.

FIG. 5B is an explanatory diagram illustrating an example of the stay frame data accumulated in the analysis information storage 22.

FIG. 5C is an explanatory diagram illustrating an example of the stay frame data accumulated in the analysis information storage 22.

FIG. 6 is an explanatory diagram illustrating a process performed by an arm action state determiner 34 and an access action detector 23.

FIG. 7 is an explanatory diagram illustrating a relationship among a trunk pose, an arm pose, and an access position (an upper part, a middle part, and a lower part of the display shelf).

FIG. 8A is an explanatory diagram illustrating a histogram expressing the number of accesses at each position of the display shelf area.

FIG. 8B is an explanatory diagram illustrating a histogram expressing the number of accesses at each position of the display shelf area.

FIG. 9A is an explanatory diagram illustrating an example of the stay frame data accumulated in the analysis information storage 22.

FIG. 9B is an explanatory diagram illustrating an example of the stay frame data accumulated in the analysis information storage 22.

FIG. 10 is an explanatory diagram illustrating an example of the stay frame data accumulated in the analysis information storage 22.

FIG. 11 is an explanatory diagram illustrating an example of analysis information generated by an analysis information generator 27.

### DESCRIPTION OF EMBODIMENT

According to a first disclosure provided to solve the above problem, there is provided a personal behavior analysis device, which performs analysis pertaining to behavior of a person who picks up a commodity displaced in a display shelf area, including: an image analyzer that analyzes captured images acquired by imaging a periphery of the display shelf area, detects a person staying in front of the display shelf area, and acquires analysis information pertaining to physical states of the person; an access action detector that detects an access action, in which a target person reaches out to the display shelf area, based on the analysis information acquired by the image analyzer; a behavior determiner that determines whether or not the access action corresponds to a prescribed behavior pattern based on occurrence circumstances of the access action detected by the access action detector; and an analysis information generator that selects the access action according to whether or not the access action corresponds to the behavior pattern based on a determination result acquired by the behavior determiner and a detection result acquired by the access action detector, and generates the analysis information pertaining to the occurrence circumstances of the access action.

According to this, it is possible to generate analysis information pertaining to occurrence circumstances of the access action according to the behavior pattern of the person. Furthermore, in a case where the determination pertaining to the behavior pattern of the store employee and the customer is performed, it is possible to discriminate whether the subject of the access action is the store employee or the customer, and it is possible to acquire the analysis information pertaining to a commodity acquisition behavior of the customer with high accuracy. In addition, in a case where the determination pertaining to the behavior pattern is performed for the work item of the commodity management work performed by the store employee, it is possible to acquire the analysis information pertaining to a specific work item with high accuracy.

In addition, according to a second disclosure, the behavior determiner determines whether or not the access action corresponds to the behavior pattern of a store employee, and the analysis information generator generates the analysis information by excluding the access action corresponding to the behavior pattern of the store employee.

According to this, since the analysis information targets the commodity acquisition behavior of the customer, it is possible for the user to grasp a degree of interest of the customer with respect to the commodity based on the analysis information.

In addition, according to a third disclosure, the analysis information generator generates the analysis information by considering all access actions in a prescribed time zone as actions performed by the store employee.

According to this, normally, since the store employee does not perform the commodity management work in a peak time zone in which a plurality of customers come to the store or a time zone in which execution of another work is prescribed due to a work schedule, it is possible to consider all the access actions in the time zone as actions performed by the customer without performing determination pertaining to the behavior pattern, and thus it is possible to simplify a process of generating the analysis information.

In addition, according to a fourth disclosure, the analysis information generator generates the analysis information by detecting the number of store employees based on the captured images acquired by imaging a normal standby place of the store employee.

According to this, the store employee grasps the number of people in a normal standby place, and thus it is possible to grasp whether or not the store employee performs the commodity management work. Therefore, it is possible to discriminate whether or not all the actions are performed by the customer, and thus it is possible to effectively perform the process of generating the analysis information.

In addition, according to a fifth disclosure, the behavior pattern pertains to at least one work item of a restocking work, a disposal work, and a face up work.

According to this, the commodity management work performed by the store employee in the display shelf area is mainly a work item of any one of the restocking work, the disposal work, and the face up work. Therefore, in a case where a behavior pattern pertaining to the work item is determined, it is possible to determine whether or not the subject of the access action is the store employee with high accuracy. In addition, in a case where the determination pertaining to the behavior pattern of each work item of the commodity management work performed by the store employee is performed, it is possible to specify the work, performed by the store employee, corresponding to any one of a restocking work, a disposal work, and a face up work.

In addition, according to a sixth disclosure, the behavior determiner determines whether or not the access action corresponds to the behavior pattern of the store employee, and the analysis information generator generates the analysis information by limiting the access action corresponding to the behavior pattern of the store employee.

According to this, since the analysis information targets the commodity management work performed by the store employee, it is possible for the user to grasp an execution status of the work performed by the store employee based on the analysis information.

In addition, according to a seventh disclosure, the behavior determiner performs determination pertaining to the behavior pattern for the work item of a commodity management work performed by the store employee, and the analysis information generator generates information pertaining to work execution status of the work item as the analysis information.

According to this, it is possible for the user to grasp the execution status of the work of the prescribed work item.

In addition, according to an eighth disclosure, the behavior determiner performs determination pertaining to the behavior pattern based on the number of access actions in one staying period during which the person stays in front of the display shelf area.

According to this, in a case where attention is paid to the number of access actions (the number of accesses), it is possible to simply determine the behavior pattern with high accuracy. For example, the number of accesses is small in the case of the customer but the number of accesses is large in the case of the store employee. Therefore, it is possible to discriminate the behavior pattern of the customer from the behavior pattern of the store employee by the number of accesses.

In addition, according to a ninth disclosure, the personal behavior analysis device further includes an access position determiner that determines an access position, which is a target of the access action, of the display shelf area based on the analysis information acquired by the image analyzer, and the behavior determiner generates a histogram expressing the number of access actions for each access position based on the determination result acquired by the access position determiner, and determines the behavior pattern based on the histogram.

According to this, in a case where attention is paid to the number of access actions for each access position, it is possible to simply determine the behavior pattern with high accuracy. For example, in the case of the customer, the customer reaches out to only a part of the display shelf area. However, in the case of the store employee, the store employee evenly reaches out to the whole display shelf area. Therefore, in a case where the histogram expressing the number of accesses for each access position is generated, it is possible to determine the behavior pattern with high accuracy.

In addition, according to a tenth disclosure, there is provided a personal behavior analysis system, which performs analysis pertaining to behavior of a person who picks up a commodity displaced in a display shelf area, including: a camera that images a periphery of the display shelf area; and a plurality of information processing devices, in which any one of the plurality of information processing devices includes an image analyzer that analyzes captured images acquired by imaging a periphery of the display shelf area by the camera, detects a person staying in front of the display shelf area, and acquires analysis information pertaining to physical states of the person; an access action detector that detects an access action, in which a target person reaches out to the display shelf area, based on the analysis information acquired by the image analyzer; a behavior determiner that determines whether or not the access action corresponds to a prescribed behavior pattern based on occurrence circumstances of the access action detected by the access action detector; and an analysis information generator that selects the access action according to whether or not the access action corresponds to the behavior pattern based on a determination result acquired by the behavior determiner and a detection result acquired by the access action detector, and generates the analysis information pertaining to the occurrence circumstances of the access action.

According to this, similar to the first disclosure, it is possible to generate the analysis information pertaining to the occurrence circumstances of the access action according to the behavior pattern of the person. Particularly, in a case where the determination pertaining to the behavior pattern of the store employee and the customer is performed, it is possible to discriminate whether the subject of the access action of reaching out to the display shelf area is the store employee or the customer with high accuracy, and it is possible to acquire analysis information pertaining to the commodity acquisition behavior of the customer with high accuracy.

In addition, according to an eleventh disclosure, there is provided a personal behavior analysis method of causing an information processing device to perform an analysis process pertaining to behavior of a person who picks up a commodity displaced in the display shelf area, the personal behavior analysis method including: analyzing captured images acquired by imaging a periphery of the display shelf area, detecting a person staying in front of the display shelf area, and acquiring analysis information pertaining to physical states of the person; detecting an access action, in which a target person reaches out to the display shelf area, based on the analysis information acquired in the analyzing; determining whether or not the access action corresponds to a prescribed behavior pattern based on occurrence circumstances of the access action acquired in the detecting; and selecting the access action according to whether or not to correspond to the behavior pattern based on a determination result acquired in determining and a detection result acquired in the detecting of the access action, and generating the analysis information pertaining to occurrence circumstances of the access action.

According to this, similar to the first disclosure, it is possible to generate the analysis information pertaining to the occurrence circumstances of the access action according to the behavior pattern of the person. Particularly, in a case where the determination pertaining to the behavior pattern of the store employee and the customer is performed, it is possible to discriminate whether the subject of the access action of reaching out to the display shelf area is the store employee or the customer with high accuracy, and it is possible to acquire analysis information pertaining to the commodity acquisition behavior of the customer with high accuracy.

Hereinafter, an embodiment of the present disclosure will be described with reference to the accompanying drawings.

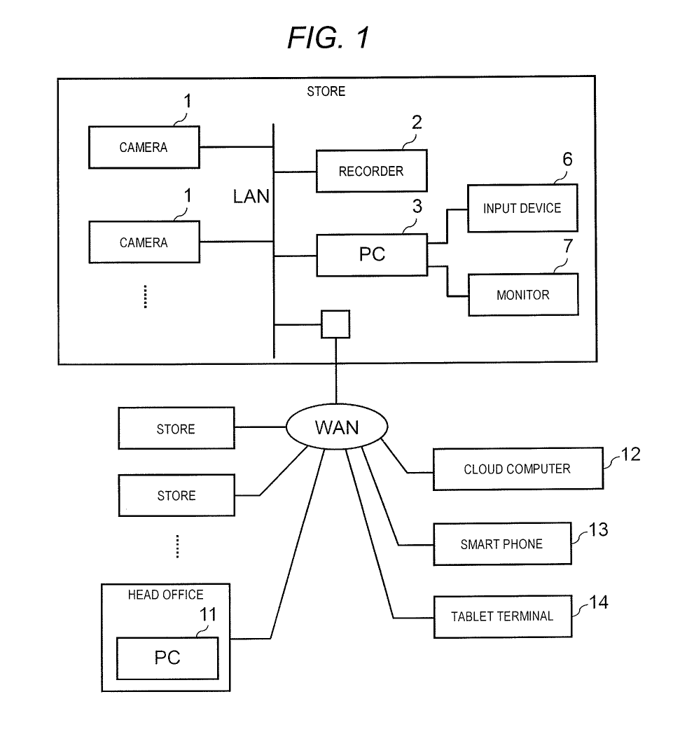

FIG. 1 is a whole configuration diagram illustrating a personal behavior analysis system according to the embodiment. The personal behavior analysis system is constructed while targeting retail store chains, such as convenience stores, and includes cameras (imaging device) 1, recorder (recording device) 2, and PC (browsing device) 3.

Cameras 1 are installed in appropriate places in a store, inside of the store is imaged by cameras 1, and captured images of inside the store, which are imaged by cameras 1, are accumulated in recorder 2.

PC 3 is connected to input device 6, such as a mouse, that is used in a case where a user, such as a store manager, performs various input operations, and monitor (display device) 7 that displays a monitoring screen. PC 3 is installed in an appropriate place in the store. It is possible for the user to browse the captured images of inside the store, which are imaged by cameras 1, using the monitoring screen displayed on monitor 7 in real time. and, in addition, it is possible for the user to browse past captured images of inside the store, which are recorded in recorder 2.

In addition, camera 1, recorder 2, and PC 3 are installed in each of a plurality of stores, and PC 11 is installed in a head office which generalizes the plurality of stores. It is possible to browse the captured images of the inside the store, which are imaged by camera 1, in real time using PC 11. In addition, it is possible to browse the past captured images (moving images) of the inside the store, which are recorded in recorder 2, and thus it is possible to recognize a status of the inside the store at the head office.

PC 3 installed in the store is configured as a personal behavior analysis device that performs analysis pertaining to behavior of a person of the inside the store. The analysis information generated using PC 3 can be browsed by a user on a side of the store using PC 3 installed in the store, for example, the store manager. Furthermore, The analysis information is transmitted to PC 11 installed in the head office, and can be browsed by a user on a side of the head office using PC 11 installed in the head office, for example, a supervisor who supervises or makes a proposal with respect to each store in an charged area. PCs 3 and 11 are configured as browsing devices that are used to browse the analysis information.

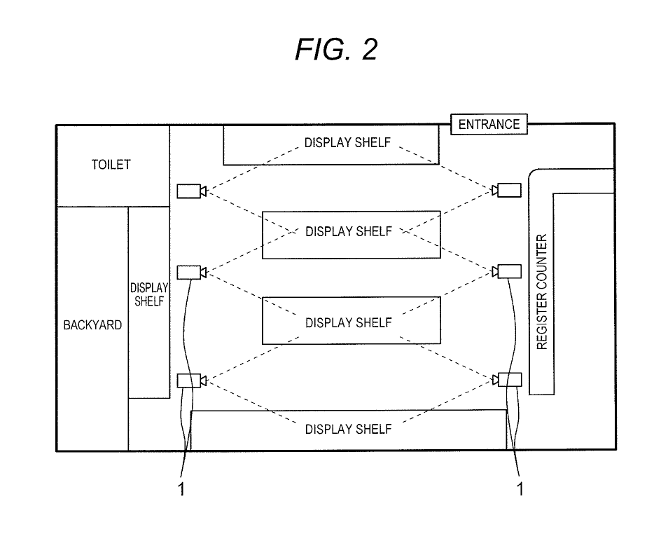

Subsequently, a layout of the store and installation status of cameras 1 will be described. FIG. 2 is a plan view illustrating the layout of the store and the installation status of cameras 1.

In the store, an entrance door, display shelves, a register counter, and the like are provided. The display shelves (display shelf area) are installed according to the types of commodities such as fast food, cooked rice (commodities such as rice balls, lunch boxes, and sushi), processed food, fancy goods, fresh food, magazines, and newspaper. A customer enters the store from the entrance door, moves in the store through passages between the display shelves, heads to the register counter with a commodity in a case where the customer finds a desired commodity, and leaves the store from the entrance door after paying price (paying the charge) at the register counter.

In addition, in the store, the plurality of cameras 1 which image inside the store (monitoring area) are installed. Cameras 1 are installed in appropriate positions on ceiling above the passages inside the store. Specifically, in the example illustrated in FIG. 2, box-shaped cameras having limited visual angles are used as cameras 1, and it is possible to image a person who is staying in front of the display shelf from an obliquely upward of a lateral side using the cameras 1. Therefore, a status of a person's action (access action) of reaching out to the display shelf in order to pick up a commodity displayed on the display shelf appears in the captured images acquired by cameras 1.

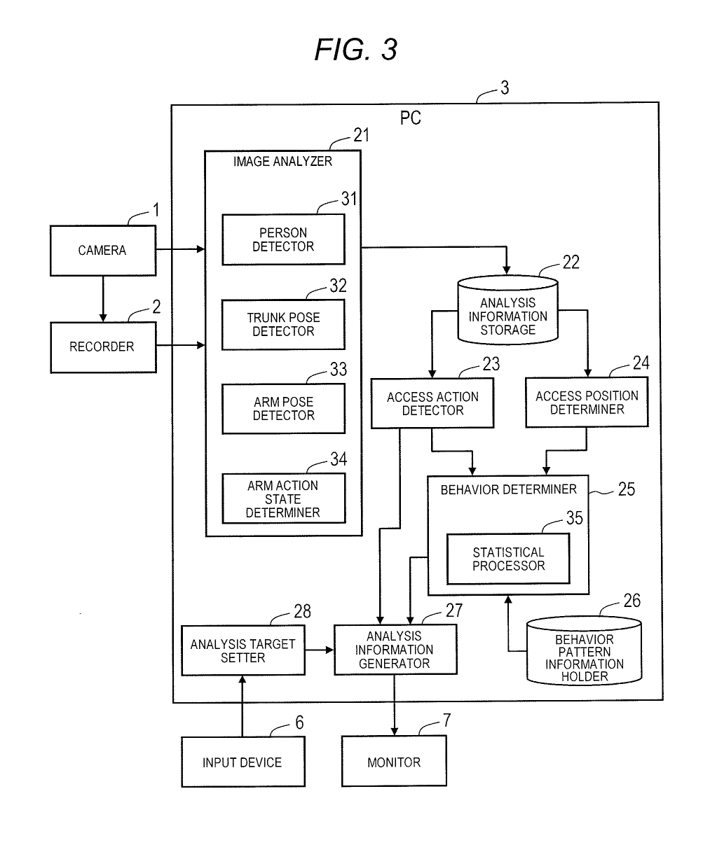

Subsequently, a schematic configuration of PC 3 illustrated in FIG. 1 will be described. FIG. 3 is a functional block diagram illustrating a schematic configuration of PC 3.

PC 3 includes image analyzer 21, analysis information storage 22, access action detector 23, access position determiner 24, behavior determiner 25, behavior pattern information holder 26, analysis information generator 27, and analysis target setter 28.

Image analyzer 21 analyzes the captured images acquired by imaging a periphery of the display shelf area by the cameras, detects the person staying in front of the display shelf area, and acquires analysis information pertaining to physical states of the person. Image analyzer 21 includes person detector 31, trunk pose detector 32, arm pose detector 33, and arm action state determiner 34. The captured images are input to image analyzer 21 from cameras 1 or recorder 2. Meanwhile, it is possible to use a well-known person recognition technology, a behavior recognition technology, or the like in a process performed by image analyzer 21.

Person detector 31 detects the person staying in front of display shelf area (display shelf) from the captured images. Specifically, person detector 31 discriminates a display shelf, in front of which the person stays. A plurality of display shelves are arranged according to categories (types) of the commodities. In a case where a display shelf corresponding to a position where the person is staying is specified, it is possible to discriminate a commodity of a category with which the person is in interested.

Trunk pose detector 32 detects a trunk pose (Trunk Pose) for each person detected by person detector 31. The trunk pose indicates a pose of the trunk of a human body in a case where the person reaches out to the display shelf. In the embodiment, trunk pose detector 32 detects three poses of an erect pose (standing) in which the person stands erect, a forward bending pose (bending) in which the person stands while bending forward, and a sitting-down pose (sitting) in which the person folds knees and lowering waist are detected. The trunk pose is determined based on shapes of a trunk, which are acquired by dividing the trunk of a human body excluding arms into a plurality of areas, for example, five areas including the head, the trunk, the waist, and the upper leg and the lower leg, and which are prescribed according to positional relationship between the respective areas.

Arm pose detector 33 detects an arm pose (Arm Pose) for each person detected by person detector 31. The arm pose indicates a pose of the arm in a case where the person reaches out to the display shelf. In the embodiment, arm pose detector 33 detects a 6-stage stretching pose from a first stretching pose (st1) in which the person reaches out downward to a sixth stretching pose (st6) in which the person reaches out upward, and a bending pose (be) in which the person folds the arm. The arm pose is determined based on a positional relationship (angle or the like) between the trunk and the arm of the human body, and a height of the arm from the ground.

Arm action state determiner 34 determines an arm action state (Arm Action) for each person based on the arm pose (Arm Pose) detected by arm pose detector 33. The arm action state indicates a state of bending and stretching action of the arm. In the embodiment, two states including an arm stretching state (STRETCH) and an arm bending state (BEND) are determined.

In image analyzer 21, processes of trunk pose detector 32, arm pose detector 33, and arm action state determiner 34 are performed for each frame from which the staying person is detected by person detector 31, stay frame data which is a processing result is output from image analyzer 21, and the stay frame data is accumulated in analysis information storage 22.

Access action detector 23 detects an access action, in which a target person reaches out to the display shelf area (display shelf), based on the analysis information acquired by image analyzer 21, and, particularly, the arm action state (Arm Action) determined by arm action state determiner 34. In this process, in a case where, after the arm action state is changed from the bending state (BEND) to the stretching state (STRETCH), and the arm action state returns to the bending state again, it is determined that the person performs one access action in which the person reaches out and withdraws.

Access position determiner 24 determines an access position, which is a target of the access action, of the display shelf area, that is, a position (the upper part, the middle part, or the lower part) of the display shelf area (display shelf) to which the person reaches out based on analysis information acquired by image analyzer 21, particularly, the trunk pose (Trunk Pose) and the arm pose (Arm Pose) which are respectively detected by trunk pose detector 32 and arm pose detector 33. In this process, the access position is acquired for each access action detected by access action detector 23.

Behavior determiner 25 determines whether or not the access action corresponds to a prescribed behavior pattern based on occurrence circumstances of the access action detected by access action detector 23.

Here, behavior determiner 25 includes statistical processor 35. Statistical processor 35 counts the access action for each determination target person in one staying period during which the person stays in front of the display shelf area, and acquires the number of access actions (the number of accesses). At this time, in a case where the access action is counted for each position of the display shelf area based on the access position for each access action acquired by the access position determiner, the number of accesses in each position of the display shelf area is acquired, and a histogram, which illustrates the number of accesses in each position of the display shelf area, is generated.

Furthermore, behavior determiner 25 maintains the histogram acquired by statistical processor 35 for each person in behavior pattern information holder 26, compares the histogram with a reference histogram, acquires a degree of similarity between both the histograms, and determines whether or not the access action corresponds to the prescribed behavior pattern based on the degree of similarity.

Particularly, in the embodiment, a reference histogram based on a behavior pattern of a store employee is held in behavior pattern information holder 26. In a case where the reference histogram pertaining to the store employee is compared with a histogram pertaining to the determination target person, it is possible to determine whether or not the access action corresponds to the behavior pattern of the store employee, that is, whether or not a subject of the access action is the store employee.

In addition, in the embodiment, the reference histogram based on behavior pattern of each work item of a commodity management work performed by the store employee is held in behavior pattern information holder 26. In a case where the reference histogram pertaining to each work item is compared with the histogram pertaining to the determination target person, it is possible to determine a behavior pattern of the work item to which the access action corresponds, that is, the work item performed by the store employee.

Analysis information generator 27 selects the access action according to whether or not the access action corresponds to the prescribed behavior pattern based on a detection result acquired by access action detector 23 and a determination result acquired by behavior determiner 25, and generates the analysis information pertaining to occurrence circumstances of the access action. The analysis information generated by analysis information generator 27 is displayed on monitor 7. Meanwhile, the analysis information may be output by a printer which is not illustrated in the drawing.

Particularly, analysis information generator 27 counts the access action detected by access action detector 23 for each prescribed unit time, acquires the number of accesses for each unit time, and generates a histogram indicative of a time shift status of the number of accesses as the analysis information.

Here, in the embodiment, behavior determiner 25 determines whether or not the access action corresponds to the behavior pattern of the store employee, that is, whether or not the subject of the access action is the store employee. Therefore, in a case where an access action, which is determined to be performed by the store employee by analysis information generator 27, is excluded based on the determination result acquired by behavior determiner 25, it is possible to generate analysis information pertaining to the customer. In addition, in a case where the access action is limited to the access action determined to be performed by the store employee, it is possible to generate the analysis information pertaining to the store employee.

The analysis information pertaining to the customer and the store employee is generated according to selection of the user. That is, in the embodiment, an analysis target is set by analysis target setting unit 28 according to an input operation performed by the user who selects an analysis target (the customer and the store employee), and analysis information generator 27 generates the analysis information based on the analysis target set by analysis target setter 28. Therefore, the analysis information pertaining to any one of the customer and the store employee is generated according to user's need.

In addition, in the embodiment, the access position determiner 24 determines the access position (the upper part, the middle part, and the lower part) in the display shelf area (display shelf). Therefore, it is possible for analysis information generator 27 to generate the analysis information pertaining to occurrence circumstances of the access action in each position in the display shelf area based on the determination result acquired by access position determiner 24. Particularly, in a case where the access action detected by access action detector 23 is counted for each access position and the number of accesses is acquired for each access position, it is possible to generate analysis information pertaining to the number of accesses to each position in the display shelf area.

Here, in a case where the analysis information pertains to the customer, it is possible for the user to grasp a degree of interest of a commodity in each position (display shelf upper part, the middle part, and the lower part) in the display shelf area from the analysis information. In addition, in a case where the analysis information pertains to the store employee, it is possible for the user to grasp an execution status of the work in each position in the display shelf area from the analysis information.

In addition, analysis information generator 27 determines that all the access actions in a prescribed time zone are not actions performed by the store employee, that is, actions performed by the customer, and generates the analysis information.

The store employee does not perform the commodity management work in a peak time zone in which a plurality of customers come to the store. In addition, in a time zone which is prescribed to perform a work other than the commodity management work, for example, a payment work at the register counter in a work schedule, the store employee does not perform the commodity management work. Here, in the embodiment, in the time zone in which the store employee does not perform the commodity management work, the analysis information is generated while all the detected access actions are considered as the actions performed by the customer.

Meanwhile, each of the units of PC 3 illustrated in FIG. 3 is realized by causing the processor (CPU) of PC 3 to execute personal behavior analysis programs (instructions) preserved in a memory such as an HDD. The program is introduced to PC 3 as an information processing device in advance and is configured as a dedicated device. In addition, the program may be recorded in an appropriate program recording medium as an application program which operates on a prescribed OS, or may be provided to the user through a network.

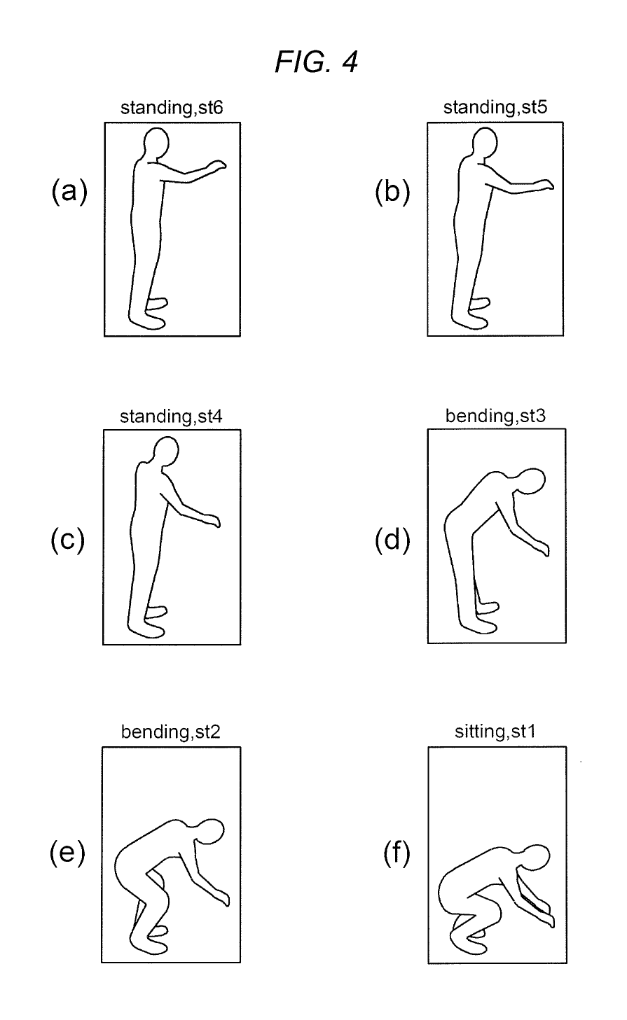

Subsequently, a process performed by trunk pose detector 32 and arm pose detector 33 of image analyzer 21 illustrated in FIG. 3 will be described. FIG. 4 is an explanatory diagram illustrating an example of a body pose in a case where a person reaches out to a display shelf area (display shelf).

In the embodiment, trunk pose detector 32 of image analyzer 21 detects a trunk pose (Trunk Pose) indicative of a pose of a trunk of a human body in a case of reaching out to the display shelf area (display shelf) for each person, and arm pose detector 33 detects the arm pose (Arm Pose) indicative of a pose of the arm in a case of stretching out the arm to the display shelf for each person.

Here, in the embodiment, three poses including an upright pose (standing), a forward bending pose (bending), and a sitting-down pose (sitting) are detected as the trunk pose (Trunk Pose). In addition, six stretching poses from the first stretching pose (st1) to the sixth stretching pose (st6), in which angles acquired in the case of stretching out the arm are different from each other, and the bending pose (be) of folding the arm, are detected as the arm pose (Arm Pose).

FIG. 4(a) illustrates a case of reaching out to the upper part of the display shelf, that is, a case in which the access position is the upper part of the display shelf. The trunk pose is the upright pose (standing) and the arm pose is the sixth stretching pose (st6). FIG. 4(b) illustrates a case where the access position is the upper part of the display shelf. The trunk pose is the upright pose (standing) and the arm pose is the fifth stretching pose (st5).

FIG. 4(c) illustrates a case of reaching out to the middle part of the display shelf, that is, a case where the access position is the middle part of the display shelf. The trunk pose is the upright pose (standing) and the arm pose is the fourth stretching pose (st4). FIG. 4(d) illustrates a case where the access position is the middle part of the display shelf. The trunk pose is the forward bending pose (bending) and the arm pose is the third stretching pose (st3).

FIG. 4(e) illustrates a case of reaching out to a lower part of the display shelf, that is, a case where the access position is the lower part of the display shelf. The trunk pose is the forward bending pose (bending) and the arm pose is a second stretching pose (st2). FIG. 4(f) illustrates a case where the access position is the lower part of the display shelf. The trunk pose is the sitting-down pose (sitting) and the arm pose is the first stretching pose (st1).

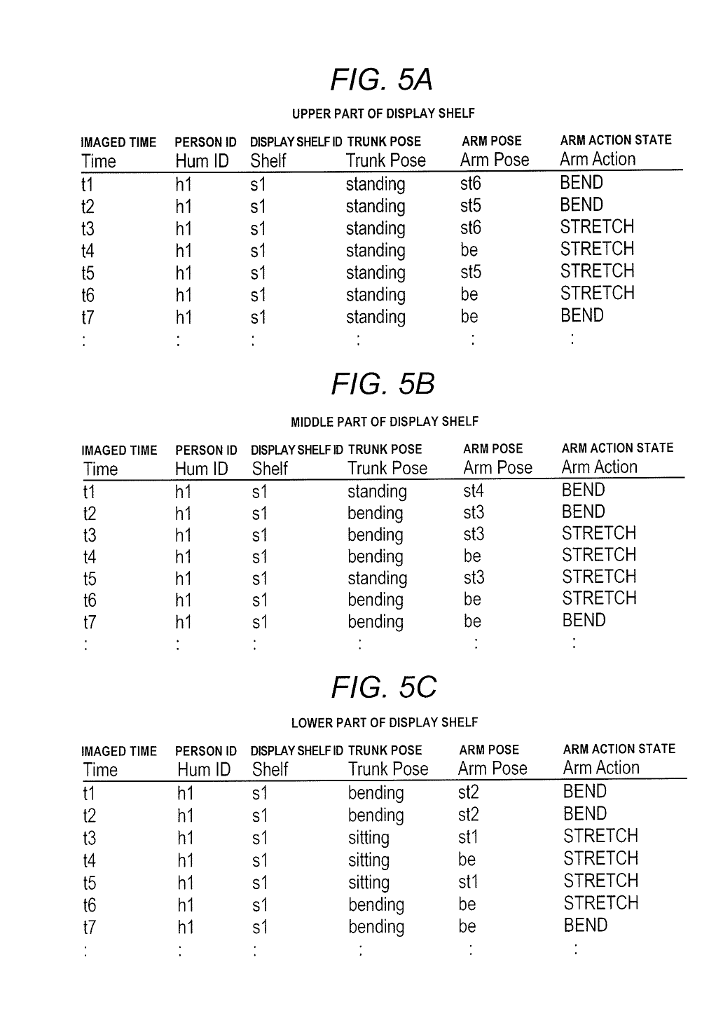

Subsequently, the stay frame data accumulated in analysis information storage 22 illustrated in FIG. 3 will be described. FIGS. 5A to 5C are explanatory diagrams illustrating examples of the stay frame data accumulated in analysis information storage 22. FIG. 5A illustrates a case where the access position is the upper part of the display shelf, FIG. 5B illustrates a case where the access position is the middle part of the display shelf, and FIG. 5C illustrates a case where the access position is the lower part of the display shelf.

In the embodiment, the stay frame data (analysis information), which is an analysis result acquired by image analyzer 21, is accumulated in analysis information storage 22. In the stay frame data, pieces of information of respective items of frame imaged time (Time), a person ID (Hum ID), a display shelf ID (Shelf), a trunk pose (Trunk Pose), an arm pose (Arm Pose), and an arm action state (Arm Action) are stored. In the stay frame data, the analysis result for each frame is stored in units of a row.

The person ID is identification information which is given to a person detected by person detector 31. The display shelf ID is identification information which is given for each display shelf in advance. In the embodiment, person detector 31 detects the person from the captured images, discriminate a display shelf, in front of which the person stays, the display shelf, and a relevant display shelf ID is stored in the stay frame data.

The trunk pose (Trunk Pose) is a detection result acquired by trunk pose detector 32, indicates the pose of the trunk of the human body in a case of reaching out to the display shelf as described above, and includes three poses of the upright pose (standing), the forward bending pose (bending), and the sitting-down pose (sitting). The arm pose (Arm Pose) is a detection result acquired by arm pose detector 33, indicates a pose of the arm in a case of stretching out the arm to the display shelf, and includes the six stretching poses from the first stretching pose (st1) to the sixth stretching pose (st6), in which the angles acquired in the case of stretching out the arm are different from each other, and the bending pose (be). The arm action state (Arm Action) is an arm determination result acquired by arm action state determiner 34, indicates an arm bending and stretching action state, and includes two states of the stretching state (STRETCH) and the bending state (BEND).

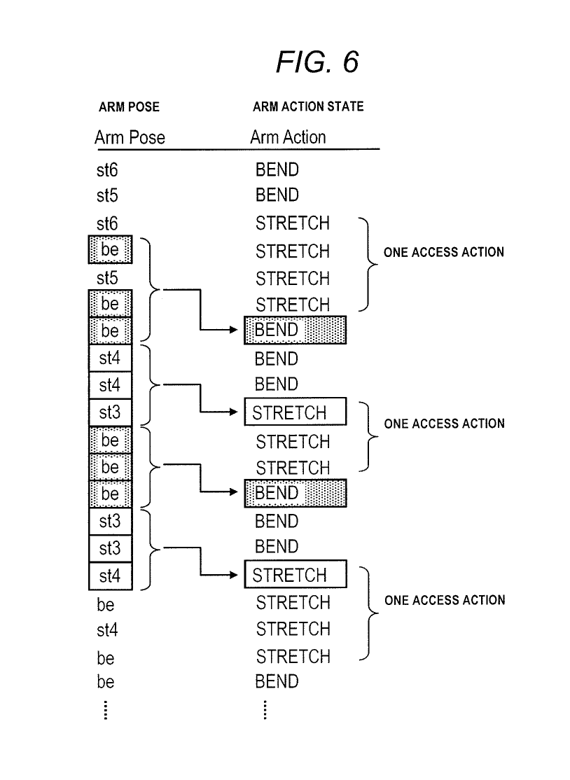

Subsequently, a process performed by arm action state determiner 34 and access action detector 23 illustrated in FIG. 3 will be described. FIG. 6 is an explanatory diagram illustrating the process performed by arm action state determiner 34 and access action detector 23.

In the embodiment, arm action state determiner 34 determines the arm action state based on arm pose detected by arm pose detector 33, and the arm action state changes according to change in the arm pose. At this time, in a case where an arm pose conflicting with the arm action state is detected in a prescribed number of frames, the arm action state is changed. That is, in a case where the number of frames, in which the arm pose conflicting with the arm action state is detected, is counted, in a case where a counted value reaches a prescribed number of frames (for example, 3 frames), the arm action state is changed.

Specifically, in a case where the arm action state is the stretching state (STRETCH) and the bending pose (be) conflicting with the stretching state is detected by a prescribed number of frames, the arm action state is changed into the bending state (BEND). In addition, in a case where the arm action state is the bending state (BEND) and the stretching poses (st1 to st6) conflicting with the bending state are detected by a prescribed number of frames, the arm action state is changed into the stretching state (STRETCH).

Meanwhile, in a case where the frame is counted, the stretching poses (st1 to st6) and the bending pose (be) may not be necessarily continued. In addition, in a case where the arm action state is changed, the counted value is reset.

Access action detector 23 detects the access action based on the arm action state (Arm Action) stored in the stay frame data. In a case where the arm action state is changed from the bending state (BEND) to the stretching state (STRETCH) and then returns to the bending state again, it is determined that one access action, in which a person reaches out and withdraws, is performed.

As described above, since arm action state determiner 34 determines the arm action state based on the arm poses in a prescribed number of frames, there is a case where the arm action state is different from the arm pose at that time. However, since the arm pose is determined using a plurality of frames, it is possible to prevent deterioration in accuracy of the arm action state due to erroneous detection of the arm pose, and it is possible to detect the access action by access action detector 23 with high accuracy.

Subsequently, a process performed by access position determiner 24 of FIG. 3 will be described

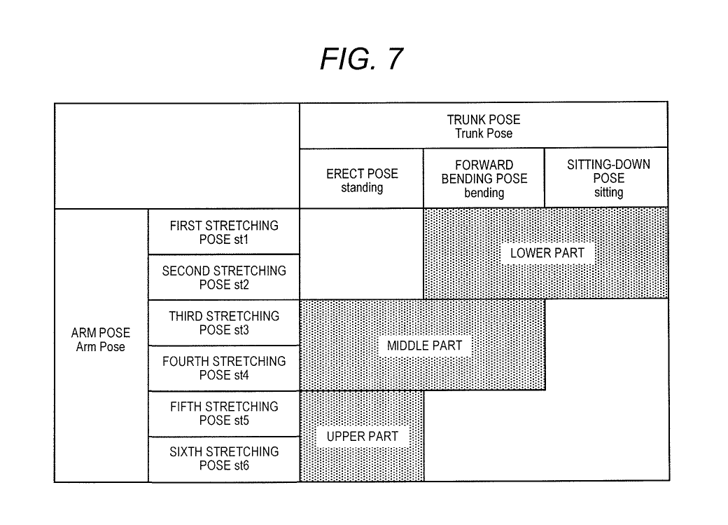

FIG. 7 is an explanatory diagram illustrating a relationship among the trunk pose, the arm pose, and the access position (the upper part, the middle part, and the lower part of the display shelf).

In the embodiment, access position determiner 24 determines the access position of the display shelf area, that is, the position (the upper part, the middle part, and the lower part) of the display shelf area (display shelf), to which the person reaches out, based on the trunk pose and the arm pose which are respectively detected by trunk pose detector 32 and arm pose detector 33 of image analyzer 21.

Here, in the case of reaching out to the upper part of the display shelf, that is, the case where the access position is the upper part of the display shelf, the trunk pose is the upright pose and the arm pose is any one of the fifth stretching pose and the sixth stretching pose (see FIG. 5A).

In a case of reaching out to the middle part of the display shelf, that is, the access position is the middle part of the display shelf, the trunk pose is any one of the upright pose and the forward bending pose, and the arm pose is any one of the third stretching pose and the fourth stretching pose (see FIG. 5B).

In a case of reaching out to the lower part of the display shelf, that is, the access position is the lower part of the display shelf, the trunk pose is any one of the forward bending pose and the sitting-down pose, and the arm pose is any one of the first stretching pose and the second stretching pose (see FIG. 5C).

As described above, since a combination of the trunk pose and the arm pose is different according to the access position (the upper part, the middle part, or the lower part of the display shelf), it is possible to determine the access position based on the trunk pose and the arm pose.

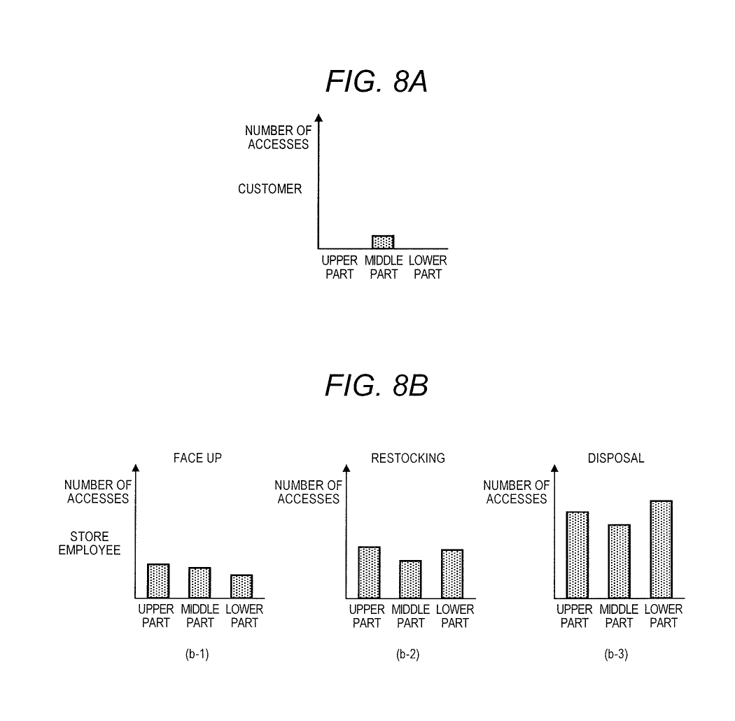

Subsequently, a process performed by behavior determiner 25 illustrated in FIG. 3 will be described. FIGS. 8A and 8B explanatory diagrams illustrating histograms expressing the number of accesses of each position of the display shelf area, FIG. 8A illustrates a case of the customer, and (b-1), (b-2), and (b-3) of FIG. 8B respectively illustrate cases in which the work performed by the store employee corresponds to the face up work, restocking work, and the disposal work.

In the embodiment, statistical processor 35 of behavior determiner 25 counts the access action in one staying period of staying in front of the display shelf area for each determination target person for each position (the upper part, the middle part, and the lower part of the display shelf) of the display shelf area, acquires the number of accesses in each position of the display shelf area, and generates a histogram expressing the number of accesses in each position of the display shelf area.

Here, in a case of the customer, if the customer finds a commodity to purchase or an interested commodity among commodities displayed on the display shelf, the customer reaches out to the display shelf in order to pick up the commodity. At this time, a few numbers of commodities are picked up by the customer at most. In addition, a range to which the customer reaches out is a part of the display shelf, and there are few cases where the customer reaches out to all the upper, middle, and lower parts of the display shelf. Therefore, as illustrated in FIG. 8A, the number of accesses is small and the number of access positions is small in the histogram.

In contrast, in a case of the store employee, the store employee performs a commodity management work, such as a work of rearranging commodities on the display shelf, in front of the display shelf. At this time, the store employee frequently moves hands. In addition, since the commodity management work is performed while targeting the whole one display shelf, the store employee evenly reaches out for the whole display shelf. Therefore, in the histograms, the number of accesses is large and the number of access positions is also large, as illustrated in (b-1), (b-2), and (b-3) of FIG. 8B.

In addition, in the case of the (above-described) store employee, the store employee performs each of the works, such as a face up work of rearranging commodities on a display shelf such that the commodities are aligned in front of the display shelf, a restocking work of arranging new commodities on the display shelf, and a disposal work of picking up unsold commodities from the display shelf. However, the access action occurrence circumstances are different according to work items.

That is, in a case of the face up work, the face up work is a work of moving the commodities on the back side of the display shelf to the front side, and an action, in which the store employee reaches out and withdraws, is regularly repeated. There is a case where a plurality of displayed commodities are collectively handled. Therefore, the number of accesses is relatively small in the histogram, as illustrated in (b-1) of FIG. 8B. Meanwhile, in addition to the face up work, an arrangement work, such as a volume display work, in which commodities are collected at the center of the shelf in order to reduce unsold feelings, is performed. The arrangement work is similar to the case of the face up work.

In addition, in a case of the restocking work, the restocking work is a work of picking up new commodities stuck in a cart and arranging the new commodities on the display shelf. Similar to the case of the face up work, the restocking work repeats the action of reaching out and withdrawing, and, in addition, there is a case where a plurality of commodities are collectively handled. In addition to the work of arranging the new commodities on the display shelf, a work of rearranging the commodities which are previously displayed on the display shelf is simultaneously performed. Therefore, in the histogram, the number of accesses is larger than the case of the face up work, as illustrated in (b-2) of FIG. 8B.

In addition, in a case of the disposal work, the disposal work is a work of picking up a commodity on the display shelf, and the action of reaching out and withdrawing is repeatedly performed. However, unlike the face up work and the restocking work, there are few cases where a plurality of commodities are collectively handled. The disposal work is a work, in which the commodities on the display shelf are picked up one by one, expiration dates of the commodities are viewed, and it is recognized whether or not the picked-up commodity is a disposal target. Therefore, accordingly, in the histogram, the number of accesses is larger than those of the face up work and the restocking work, as illustrated in (b-3) of FIG. 8B.

As described above, the behavior patterns of the customer and the store employee are different from each other, and the histograms are significantly different from each other. In addition, the behavior pattern becomes different according to the work item of the commodity management work performed by the store employee, and thus the histogram becomes different for each work item.

Here, in the embodiment, behavior determiner 25 compares the histogram acquired by statistical processor 35 for each person with a reference histogram for each behavior pattern, which is held in behavior pattern information holder 26, acquires a degree of similarity between the histograms, and determines whether or not the access action corresponds to the prescribed behavior pattern based on the degree of similarity.

Here, in a case where it is merely determined whether the subject of the access action is the store employee or the customer, a reference histogram pertaining to the behavior pattern of the store employee is prepared, a degree of similarity between the histogram of the determination target person and the reference histogram is acquired, and the degree of similarity is compared with a prescribed threshold. In a case where the degree of similarity is equal to or larger than the threshold, it may be determined that the access action corresponds to the behavior pattern of the store employee.

At this time, the reference histogram for each work item of the commodity management work is prepared, and the degree of similarity between the histogram of the determination target person and the reference histogram for each work item is acquired. In a case where the degree of similarity is equal to or larger than the threshold at any one of the work items, it may be determined that the access action corresponds to the behavior pattern of the store employee.

In addition, it is possible to determine a behavior pattern of a work item to which the access action corresponds, that is, a work item which is executed by the store employee. In this case, the degree of similarity between the histogram of the determination target person and the reference histogram for each work item is acquired, and a work item of the reference histogram, in which the degree of similarity is the highest, is determined to a work item which is executed by the store employee.

Meanwhile, in the embodiment, the reference histogram for each behavior pattern is prepared in advance based on an actually measured value, and is held in behavior pattern information holder 26. In a case where the reference histogram for each behavior pattern is prepared, an appropriate statistical process, for example, standardization or normalization is performed with respect to the number of accesses for each of the plurality of people collected in the past.

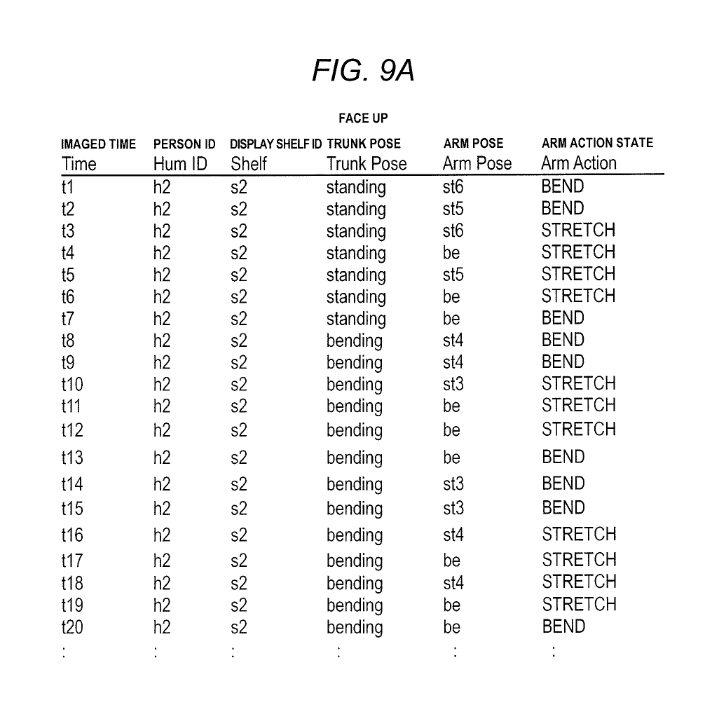

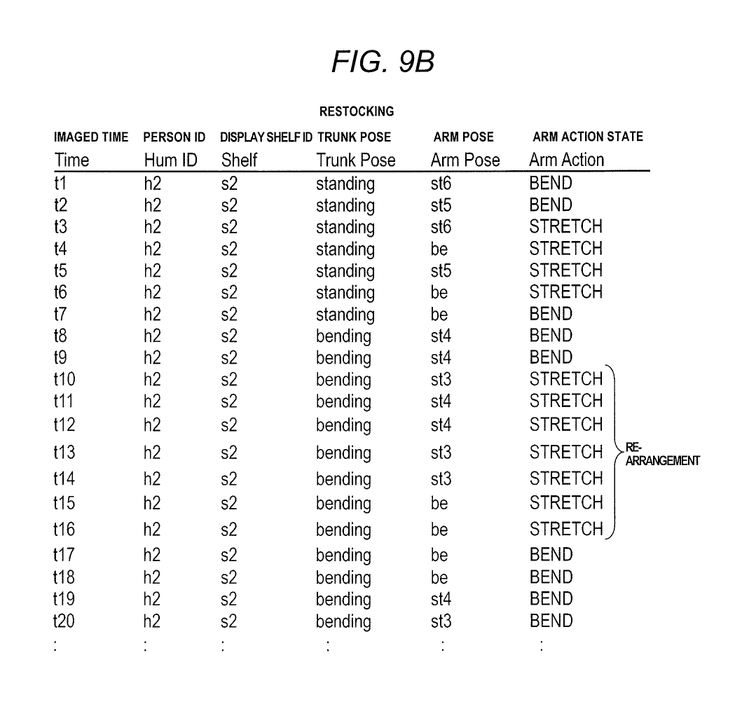

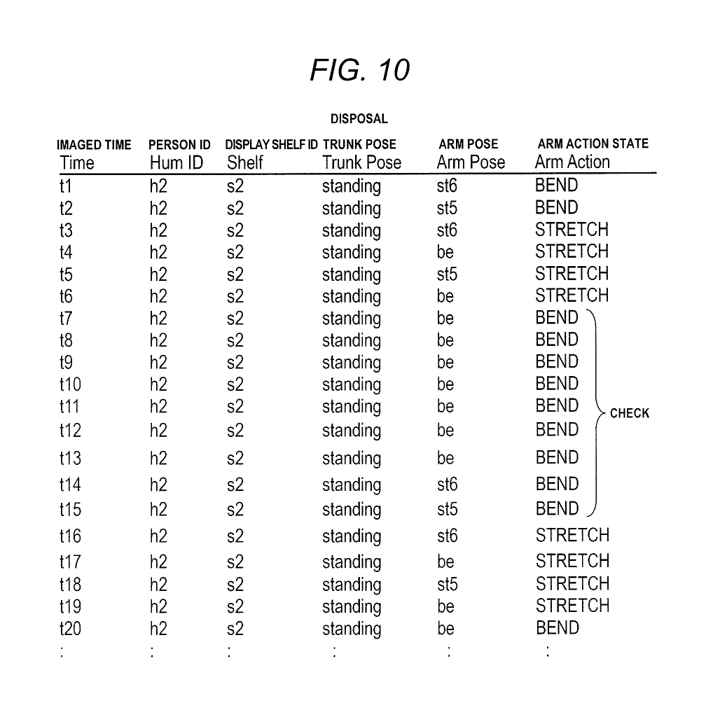

Subsequently, another process which is performed by behavior determiner 25 illustrated in FIG. 3 will be described. FIGS. 9A and 9B and FIG. 10 are explanatory diagrams illustrating examples of the stay frame data accumulated in analysis information storage 22, and FIGS. 9A and 9B and FIG. 10 respectively illustrates cases where the works executed by the store employee are the face up work, the restocking work, and the disposal work.

In the embodiment, behavior determiner 25 determines a behavior pattern for each work item pertaining to the commodity management work of the store employee, to which the access action corresponds, based on the arm action state (Arm Action).

Here, in the case of the (above-described) face up work, the face up work is a work of moving the commodities on the back side of the display shelf to the front side, and the action of reaching out and withdrawing is regularly repeated at short intervals. Therefore, continuance time of each of the stretching state (STRETCH) and the bending state (BEND) becomes short, as illustrated in FIG. 9A.

In addition, in the case of the restocking, in addition to the work of arranging new commodities on the display shelf, an arrangement work of rearranging the commodities which are previously displayed on the display shelf is performed. At this time, since the commodities are rearranged in a state in which hands are got into the display shelf, a state of reaching out is continued for a long time. Therefore, continuation time of the stretching state becomes longer, as illustrated in FIG. 9B.

In addition, in the case of the disposal work, the disposal work is a work of picking up the commodities displayed on the display shelf and checking the expiration dates of the commodities. At this time, since it takes time to check the expiration dates, the arm bending state is continued for a long time. Therefore, continuation time of the bending state becomes longer, as illustrated in FIG. 10.

As described above, based on features of the access action, particularly, the continuation time of the stretching state and the bending state which can be acquired from the arm action state (Arm Action), it is possible to determine that the access action is the commodity management work performed by the store employee, and, in addition, it is possible to determine the work item of the commodity management work performed by the store employee. Meanwhile, the work item may be determined by combining the determination based on the arm action state and the determination based on the histogram illustrated in FIG. 8.

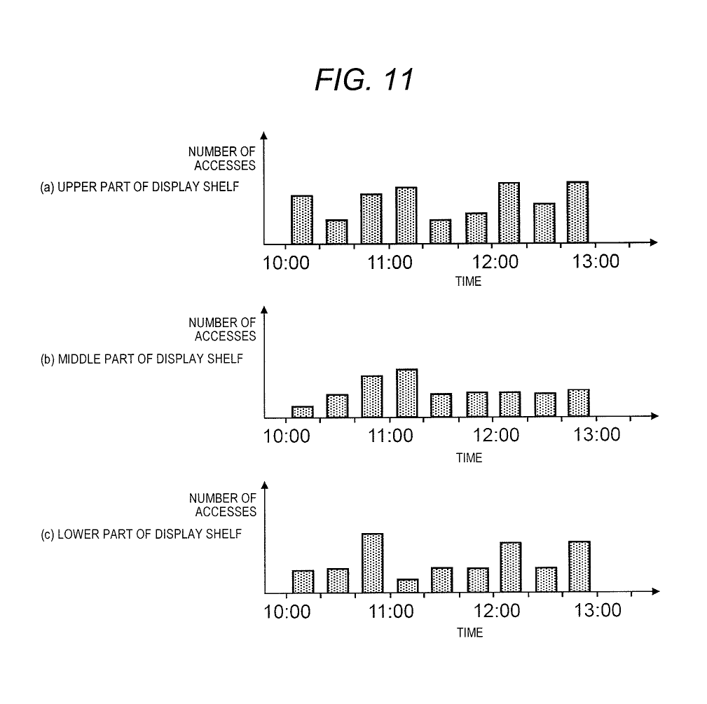

Subsequently, a process performed by analysis information generator 27 illustrated in FIG. 3 will be described. FIG. 11 is an explanatory diagram illustrating an example of the analysis information generated by analysis information generator 27. FIG. 11(a) is a histogram expressing the time shift status of the number of accesses to the upper part of the display shelf. FIG. 11(b) is a histogram expressing the time shift status of the number of accesses to the middle part of the display shelf. FIG. 11(c) is a histogram expressing the time shift status of the number of accesses to the lower part of the display shelf.

In the embodiment, analysis information generator 27 generates the analysis information pertaining to occurrence circumstances of the access action for each unit time (time zone) based on the determination result acquired by behavior determiner 25 and the detection result acquired by access action detector 23. Particularly, in the embodiment, access position determiner 24 determines the access position (the upper part, the middle part, or the lower part) inside the display shelf area (display shelf), and analysis information generator 27 acquires the number of accesses for each unit time for each position of the display shelf area. Therefore, a histogram expressing the time shift status of the number of accesses for each position (the upper part, the middle part, or the lower part of the display shelf) of the display shelf area is generated as the analysis information.

Meanwhile, each histogram illustrated in FIG. 11 expresses the number of accesses for each measurement time (20 minutes) of a time zone from 10 to 12.

As described above, in the embodiment, image analyzer 21 analyzes captured images acquired by imaging the periphery of the display shelf area, detects a person staying in front of the display shelf area, and acquires the analysis information pertaining to physical states of the person, access action detector 23 detects an access action, in which a target person reaches out to the display shelf area, based on the analysis information acquired by the image analyzer 21, behavior determiner 25 determines whether or not the access action corresponds to a prescribed behavior pattern based on occurrence circumstances of the access action detected by the access action detector 23, and analysis information generator 27 selects the access action according to whether or not the access action corresponds to the behavior pattern based on a determination result acquired by the behavior determiner 25 and a detection result acquired by the access action detector 23, and generates the analysis information pertaining to the occurrence circumstances of the access action.

According to this, it is possible to generate the analysis information pertaining to the occurrence circumstances of the access action according to the behavior pattern of the person. Furthermore, in a case where the determination pertaining to the behavior pattern of the store employee and the customer is performed, it is possible to discriminate whether the subject of the access action is the store employee or the customer with high accuracy, and it is possible to acquire analysis information pertaining to the commodity acquisition behavior of the customer with high accuracy. In addition, in a case where the determination pertaining to the behavior pattern is performed for the work item of the commodity management work performed by the store employee, it is possible to acquire the analysis information pertaining to a specific work item with high accuracy.

In addition, in the embodiment, behavior determiner 25 determines whether or not the access action corresponds to the behavior pattern of the store employee, and analysis information generator 27 excludes the access action corresponding to the behavior pattern of the store employee, and generates the analysis information. According to this, since the analysis information targets the commodity acquisition behavior of the customer, it is possible for the user to grasp a degree of interest of the customer with respect to the commodity based on the analysis information.

In addition, in the embodiment, analysis information generator 27 considers all access actions in a prescribed time zone as actions performed by the store employee, and generates the analysis information. According to this, normally, since the store employee does not perform the commodity management work in a peak time zone in which a plurality of customers come to the store or a time zone in which execution of another work is prescribed due to a work schedule, it is possible to consider all the access actions in the time zone as actions performed by the customer without performing determination pertaining to the behavior pattern, and thus it is possible to simplify a process of generating the analysis information.

Furthermore, in a case where a prescribed number of people are detected through analysis of the captured images acquired by imaging a normal standby place (in a register counter area or the like) of the store employee, it may be determined that the store employee does not perform the commodity management work, and it may be discriminated that all the access actions are performed by the customer. In contrast, in a case where only people corresponding to a prescribed number or smaller are detected in the normal standby place, it is determined that the store employee and the customer are mixed in the subject of the access action, and thus a process of generating the analysis information may be performed with respect to each of the customer and the store employee. According to this, it is possible to grasp whether or not the store employee performs the commodity management work. Therefore, it is possible to discriminate whether or not all the actions are performed by the customer, and thus it is possible to effectively perform the process of generating the analysis information.

In addition, in the embodiment, the behavior pattern pertains to at least one work item of the restocking work, the disposal work, and the face up work. According to this, the commodity management work performed by the store employee in the display shelf area is manly any one work item of the restocking work, the disposal work, and the face up work. Therefore, in a case where the behavior pattern pertaining to the work item is determined, it is possible to determine whether or not the subject of the access action is the store employee with high accuracy. In addition, in a case where determination pertaining to the behavior pattern of each work item of the commodity management work performed by the store employee is performed, it is possible to specify that the work performed by the store employee corresponds to any one of the restocking work, the disposal work, and the face up work.

In addition, in the embodiment, behavior determiner 25 determines whether or not the access action corresponds to the behavior pattern of the store employee, and analysis information generator 27 limits the access action to the access action corresponding to the behavior pattern of the store employee, and generates the analysis information. According to this, since the analysis information targets the commodity management work performed by the store employee, it is possible for the user to grasp an execution status of the work performed by the store employee based on the analysis information.

In addition, in the embodiment, behavior determiner 25 performs determination pertaining to the behavior pattern for the work item of the commodity management work performed by the store employee, and analysis information generator 27 generates the information pertaining to the execution status of the work of the work item as the analysis information. According to this, it is possible for the user to grasp the execution status of the work of the prescribed work item.

In addition, in the embodiment, behavior determiner 25 performs the determination pertaining to the behavior pattern based on the number of access actions in one staying period during which the person stays in front of the display shelf area. According to this, in a case where attention is paid to the number of access actions (the number of accesses), it is possible to simply determine the behavior pattern with high accuracy. For example, the number of accesses is small in the case of the customer but the number of accesses is large in the case of the store employee. Therefore, it is possible to discriminate the behavior pattern of the customer from the behavior pattern of the store employee by the number of accesses.

In addition, in the embodiment, the access position determiner 24 determines an access position, which is a target of the access action, of the display shelf area based on the analysis information acquired by the image analyzer 21, and behavior determiner 25 generates a histogram expressing the number of access actions for each access position based on the determination result acquired by the access position determiner 24, and determines the behavior pattern based on the histogram. According to this, in a case where attention is paid to the number of access actions for each access position, it is possible to simply determine the behavior pattern with high accuracy. For example, in the case of the customer, the customer reaches out to only a part of the display shelf area. However, in the case of the store employee, the store employee evenly reaches out to the whole display shelf area. Therefore, in a case where the histogram expressing the number of accesses for each access position is generated, it is possible to determine the behavior pattern with high accuracy.

Hereinabove, although the present disclosure has been described based on the specific embodiment, the embodiment is merely an illustration, and the present disclosure is not limited to the embodiment. In addition, all of the respective components of the personal behavior analysis device, the personal behavior analysis system, and the personal behavior analysis method according to the present disclosure, which are illustrated in the above-described embodiment, are not necessarily essential, and can be appropriately selected without departing from at least the scope of the present disclosure.

For example, in the embodiment, a retail store, such as a convenience store, is described as an example. However, the present disclosure is not limited to the retail store and can be applied to a store of a business form other than the retail store.

In addition, in the embodiment, an example in which image analyzer 21 is provided in PC 3 has been described. However, it is possible to provide a whole or a part of image analyzer 21 in camera 1. In addition, it is possible to form a whole or a part of image analyzer 21 in a dedicated device.

In addition, in the embodiment, a device provided in a store is caused to perform a process which is necessary for the personal behavior analysis. However, PC 11 provided in the head office and cloud computer 12 which form a cloud computing system may be caused to perform the necessary process, as illustrated in FIG. 1. In addition, the necessary process may be allocated to a plurality of information processing devices, and information may be delivered between the plurality of information processing devices through a communication medium, such as an IP network or a LAN, or a storage medium such as a hard disk or a memory card. In this case, the plurality of information processing devices, to which the necessary process is allocated, form the personal behavior analysis system.

Particularly, in the system configuration which includes cloud computer 12, necessary information may be displayed by mobile terminals, such as smart phone 13 and tablet terminal 14, which are connected to cloud computer 12 through the network, in addition to PCs 3 and 11 which are provided in the store and the head. Therefore, it is possible to check necessary information in an arbitrary place, such as a place where a person is visiting, in addition to the store and the head office.

In addition, in the embodiment, recorder 2 that accumulates the captured images acquired by cameras 1 is installed in the store. However, in a case where PC 11 and cloud computer 12, which are installed in the head office, are caused to execute the process necessary for the personal behavior analysis, the captured images acquired by cameras 1 may be transmitted to the head office or an operation facility of the cloud computing system, and a device installed in the head office or the operation facility may be caused to accumulate the captured images acquired by cameras 1.

### INDUSTRIAL APPLICABILITY

The personal behavior analysis device, the personal behavior analysis system, and the personal behavior analysis method according to the present disclosure have advantages in that it is possible to discriminate whether the subject of the action of reaching out to the display shelf area is the store employee or the customer, and to acquire the analysis information pertaining to the commodity acquisition behavior of the customer with high accuracy, and are useful as the personal behavior analysis device, the personal behavior analysis system, and the personal behavior analysis method which are used to perform analysis pertaining to behavior of a person who picks up a commodity displaced in the display shelf area.

### REFERENCE MARKS IN THE DRAWINGS

1 CAMERA

2 RECORDER

3 PC

11 PC

12 CLOUD COMPUTER

13 SMART PHONE

14 TABLET TERMINAL

21 IMAGE ANALYZER

22 ANALYSIS INFORMATION STORAGE

23 ACCESS ACTION DETECTOR

24 ACCESS POSITION DETERMINER

25 BEHAVIOR DETERMINER

26 BEHAVIOR PATTERN INFORMATION HOLDER

27 ANALYSIS INFORMATION GENERATOR

28 ANALYSIS TARGET SETTER

31 PERSON DETECTOR

32 TRUNK POSE DETECTOR

33 ARM POSE DETECTOR

34 ARM ACTION STATE DETERMINER

35 STATISTICAL PROCESSOR

1. A personal behavior analysis device, which performs analysis pertaining to behavior of a person who picks up a commodity displaced in a display shelf area, comprising:
an image analyzer that analyzes captured images acquired by imaging a periphery of the display shelf area, detects a person staying in front of the display shelf area, and acquires analysis information pertaining to physical states of the person;
an access action detector that detects an access action, in which a target person reaches out to the display shelf area, based on the analysis information acquired by the image analyzer;
a behavior determiner that determines whether or not the access action corresponds to a prescribed behavior pattern based on occurrence circumstances of the access action detected by the access action detector; and
an analysis information generator that selects the access action according to whether or not the access action corresponds to the behavior pattern based on a determination result acquired by the behavior determiner and a detection result acquired by the access action detector, and generates the analysis information pertaining to the occurrence circumstances of the access action.

2. The personal behavior analysis device according to claim 1,
wherein the behavior determiner determines whether or not the access action corresponds to the behavior pattern of a store employee, and
wherein the analysis information generator generates the analysis information by excluding the access action corresponding to the behavior pattern of the store employee.

3. The personal behavior analysis device according to claim 1,
wherein the analysis information generator generates the analysis information by considering all access actions in a prescribed time zone as actions performed by the store employee.

4. The personal behavior analysis device according to claim 1.
wherein the analysis information generator generates the analysis information by detecting the number of store employees based on the captured images acquired by imaging a normal standby place of the store employee.

5. The personal behavior analysis device according to claim 1,
wherein the behavior pattern pertains to at least one work item of a restocking work, a disposal work, and a face up work.

6. The personal behavior analysis device according to claim 1,
wherein the behavior determiner determines whether or not the access action corresponds to the behavior pattern of the store employee, and
wherein the analysis information generator generates the analysis information by limiting the access action corresponding to the behavior pattern of the store employee.

7. The personal behavior analysis device according to claim 6,
wherein the behavior determiner performs determination pertaining to the behavior pattern for the work item of a commodity management work performed by the store employee, and
wherein the analysis information generator generates information pertaining to work execution status of the work item as the analysis information.

8. The personal behavior analysis device according to claim 1,
wherein the behavior determiner performs determination pertaining to the behavior pattern based on the number of access actions in one staying period during which the person stays in front of the display shelf area.

9. The personal behavior analysis device according to claim 8, further comprising:
an access position determiner that determines an access position, which is a target of the access action, of the display shelf area based on the analysis information acquired by the image analyzer,
wherein the behavior determiner generates a histogram expressing the number of access actions for each access position based on the determination result acquired by the access position determiner, and determines the behavior pattern based on the histogram.

10. A personal behavior analysis system, which performs analysis pertaining to behavior of a person who picks up a commodity displaced in a display shelf area, comprising:
a camera that images a periphery of the display shelf area; and
a plurality of information processing devices,
wherein any one of the plurality of information processing devices includes
an image analyzer that analyzes captured images acquired by imaging a periphery of the display shelf area by the camera, detects a person staying in front of the display shelf area, and acquires analysis information pertaining to physical states of the person;
an access action detector that detects an access action, in which a target person reaches out to the display shelf area, based on the analysis information acquired by the image analyzer;
a behavior determiner that determines whether or not the access action corresponds to a prescribed behavior pattern based on occurrence circumstances of the access action detected by the access action detector; and
an analysis information generator that selects the access action according to whether or not the access action corresponds to the behavior pattern based on a determination result acquired by the behavior determiner and a detection result acquired by the access action detector, and generates the analysis information pertaining to the occurrence circumstances of the access action.

11. A personal behavior analysis method of causing an information processing device to perform an analysis process pertaining to behavior of a person who picks up a commodity displaced in the display shelf area, the personal behavior analysis method comprising:
a step of analyzing captured images acquired by imaging a periphery of the display shelf area, detecting a person staying in front of the display shelf area, and acquiring analysis information pertaining to physical states of the person;
a step of detecting an access action, in which a target person reaches out to the display shelf area, based on the analysis information acquired in the step of analyzing;
a step of determining whether or not the access action corresponds to a prescribed behavior pattern based on occurrence circumstances of the access action acquired in the step of detecting; and
a step of selecting the access action according to whether or not to correspond to the behavior pattern based on a determination result acquired in the step of determining and a detection result acquired in the detecting of the access action, and generating the analysis information pertaining to occurrence circumstances of the access action.
